(19) United States
(12) Patent Application Publication
(10) Pub. No.: US 2008/0162433 A1
(43) Pub. Date: Jul. 3, 2008

(54) Browsable search system

(76) Inventor: Jason Wolf, Los Gatos, CA (US)

Correspondence Address: BRAKE HUGHES BELLERMANN LLP, C/O INTELLEVATE, P.O. BOX 52050, MINNEAPOLIS, MN, 55402, US

(21) Appl. No.: 11/648,842

(22) Filed: Dec. 29, 2006

(51) Int. Cl. G06F 17/30

(52) U.S. Cl. 707/3

(57) ABSTRACT

A commonality detector may be configured to determine common subject matter associated with search results that are determined based at least in part on one or more search terms. A view generator may be configured to provide the one or more search terms, the search results and the common subject matter. A search engine may be configured to determine secondary search results based at least in part on a selection of the common subject matter.

### TECHNICAL FIELD

This description relates to search systems.

### BACKGROUND

With the growth of the Internet and the use of computers has come a corresponding growth of the amount of information available to computer users. This information may be stored in hundreds, thousands, and even millions of files and documents located on computers, servers, and other computing devices communicating through networks which may span the globe. As such, a computer user searching for a specific type of information or information on a particular subject matter of interest may need the aid of a search engine to help search the available information and return information that may be relevant to the user's search.

However, in performing such searches, even within the files of a single computing device, a search engine may return hundreds, thousands, or possibly even millions of documents or files that may be related to the computer user's desired field of search. The search results themselves may share some overlapping or common themes or subject matter that may be related in some way to the user's original subject matter, or to some related area of interest. Among the common themes or subject matter within the search results, there may exist one or more sub-categories of information related to the user's original subject matter that may be of particular interest to the user. However, for a user to manually open and review each search result to discover these sub-categories may be impractical. Furthermore, a user may wish to narrow or re-focus the search or the search results based upon the common subject matter, but again, doing so may be impractical for all but the smallest set of search results.

### SUMMARY

Various embodiments for browsable search systems are disclosed. According to an example embodiment, a system is disclosed. The system may include a commonality detector configured to determine common subject matter associated with search results determined based at least in part on one or more search terms. The system may include a view generator configured to provide the one or more search terms, the search results and the common subject matter. The system may include a search engine configured to determine secondary search results based at least in part on a selection of the common subject matter.

According to another example embodiment, a method is disclosed. The method may include determining a plurality of search results of a search based on one or more search terms, the plurality of search results including a first search result associated with first content and a second search result associated with second content. The method may also include determining common subject matter associated with the first content and the second content. The method may also include providing at least a portion of the common subject matter, other than the one or more search terms, in association with the first search result and the second search result. The method may also include providing at least a selection of the portion of the common subject matter as one or more secondary search terms for re-executing the search.

According to another example embodiment, a computer program product for searching and browsing files is disclosed, the computer program product being tangibly embodied on a computer-readable medium and including executable code that, when executed, may be configured to cause a data processing apparatus to provide a user interface. The user interface may include a first field configured to receive one or more first search terms on which to base a first search of a plurality of files, a second field configured to provide search results associated with the first search, and a third field configured to provide common subject matter, in addition to the first search terms, associated with the search results, wherein the third field may be configured to provide for a selection of at least a portion of the common subject matter as a second search term for a second search.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for a browsable search system, according to an example embodiment.

FIG. 2 is a flowchart illustrating example operations of the system of FIG. 1.

FIG. 3 is a block diagram of an example system for a browsable search system, according to an example embodiment.

FIG. 4 is a block diagram of an example system for a browsable search system, according to an example embodiment.

FIG. 5 is a block diagram of an example system for a browsable search system, according to an example embodiment.

### DETAILED DESCRIPTION

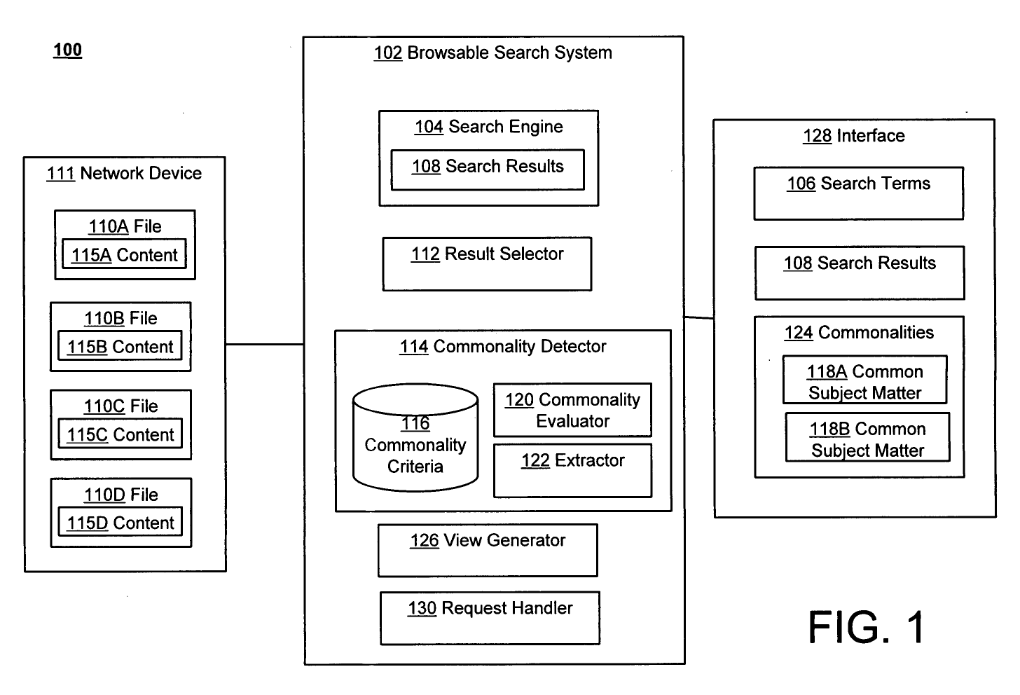

FIG. 1 is a block diagram of an example system 100 for a browsable search system 102, according to an example embodiment. In the example of FIG. 1, the system 100 may parse a plurality of results from a search, in order to determine subject matter (e.g., content) that is common among the results. This may allow a user, for example, to browse the subject matter that is common among the results of the search, in order to select (common) portions of the subject matter that may be of interest to the user, without requiring the user to individually open and view each result. The selected, common subject matter may then be used, for example, to run a subsequent search and narrow or re-focus the results.

The browsable search system 102 may be configured to determine subject matter associated with at least a portion of the results of a search. For example, the browsable search system 102 may parse the results (or a portion thereof) for strings or other content common among the results. The browsable search system 102 may then, for example, provide the results of the search in association with at least a portion of the subject matter found to be common among the results. For example, the browsable search system 102 may, based at least in part on a portion of the results of the search, determine common themes, ideas, words, or other subject matter associated with the portion of the results, and provide the common subject matter in association with the search results. Then for example, a user may browse the provided subject matter and select a portion thereof with which to execute a subsequent search.

The browsable search system 102 may include, or be associated with, a search engine 104. For example, the search engine 104 may include, or be associated with, a document retrieval system designed to help find information stored on a computer system such as the Internet, a local computer network such as a corporate intranet, a personal computer, or virtually any other computing device(s). For example, the search engine 104 may include, or may utilize, commercially-available search platforms or search engines.

The search engine 104 may perform the search based on one or more search terms 106. The search terms 106 may include one or more words, phrases, or other terms to be searched for by the search engine 104. For example, a user may provide the search terms 106 associated with a subject about which the user is interested in searching. The search engine 104 may then, for example, search a computer system or plurality of computer systems to locate files or documents associated with (e.g., including) the search terms 106.

The files or documents located by the search engine 104 based on the search terms 106 may be returned as search results 108. The search results 108, for example, may include a list of website links returned by an Internet search by the search engine 104. The search engine 104 also may categorize the search results 108 (e.g., it may determine an order of the search results 108 based on relevance to the search terms 106). For example, the most relevant of the search results 108, as determined by the search engine 104, may appear first within a listing of the search results.

The search results 108 may be associated with files 110A, 110B, 110C, and 110D. The files 110A-D may include, for example, files, websites, or other documents accessed by the search engine 104, determined relevant to the search terms 106, and associated with search results 108. For example, the search engine 104 may perform an Internet search for the search terms 106, wherein the search engine 104 may access various websites (e.g., the files 110A, 110B, 110C, and 110D) and return the search results 108 which may include links or pointers to the websites, and/or content from the websites.

The files 110A-D may be stored or located on a network device 111. The network device 111 may include one or more devices configured to store files or documents to be searched by the search engine 104. For example, the network device 111 may include or represent a database, a file server, a network (e.g., the Internet, or an intranet), a personal computer, and virtually any other computing device(s) with files, websites or other documents that may be searched by the search engine 104.

After the search engine 104 determines the search results 108, a result selector 112 may determine two or more of the search results 108 from which to determine common content, themes, words, ideas or other subject matter. For example, the search engine 104 may return 1000 results in the search results 108. Then, for example, the result selector 112 may select only the first 100 results (e.g., the most relevant results). In another example embodiment, the result selector 112 may select only those results of the search results 108 that start with a particular letter or that contain a particular word, or that were obtained from a particular source.

A commonality detector 114 may then determine, based on the search results 108, or a subset of the search results 108 as determined by the result selector 112, ideas, themes, words, content or other subject matter common among or associated with the search results 108. For example, the commonality detector 114 may determine a list of terms in the file 110A and then eliminate from the list words not found in one or more of the remaining files 110B, 110C, and 110D associated with the search results 108.

The files 110A, 110B, 110C and 110D may include content 115A, 115B, 115C and 115D. The content 115A-D may include text, graphics, images, numerical data or other content associated with the files 110A-D. For example, the content 115A may include at least a portion of a word processing document, while the content 115B may include a spreadsheet document, the content 115C may include a website, and the content 115D may include a slideshow presentation. The content 115A-D may include, or be associated with, metadata associated with the files 110A-D. For example, metadata may include information about the files 110A-D and/or the content 115A-D, including, but not limited to, information about the author, creation date, last modified date and subject matter of the content 115A-D.

The commonality criteria 116 may include criteria or rules that may be used to determine how to select, determine and/or extract ideas, phrases, words, content or other subject matter common among or associated with the search results 108. The commonality criteria 116, for example, may provide guidelines for determining a portion of the search results 108 that are to be used to determine the common subject matter (e.g., common content). For example, the commonality detector 114 may use the commonalty criteria 116 to determine a number (or percentage) of the search results 108 in which a phrase or string must be found in order to be defined as common subject matter among the search results 108. For example, the result selector 112 may provide 100 of the 1000 search results 108 to the commonality detector 114. Then, for example, the commonality criteria 116 may provide that terms found in some percentage, e.g., 50% or 75%, of the search results 108 (e.g., 50 or 75 of the 100 search results 108) may be provided by the commonality detector 114 as subject matter that is common among the search results 108.

In still other examples, the commonality criteria 116 may include commonalities among the search results 108 based on shared or common metadata. Similarly, but conversely, the commonality criteria 116 may provide for the removal of the same word in different contexts, based on metadata specifying different uses of the word in the different contexts. In still other examples, the commonality criteria 116 may specify terms or other subject matter as common, even if the terms are not exact matches, such as when a word appears with different prefixes or suffixes in different ones of the content 115A-115D.

The commonality criteria 116 may include rules to parse content associated with the search results 108. For example, the commonality criteria 116 may include rules to exclude commonly used words such as articles including “the,” “a,” and “and.” The commonality detector 114 may then, for example, parse the content 115A-D based on the commonality criteria 116 and exclude the commonly used words to determine what content is common among the search results 108.

The commonality criteria 116 may include words or phrases determined to be associated with the search terms 106, wherein the search results 108 may be parsed for the words or phrases. For example, the search terms 106 may include “office,” and the commonality criteria 116 may include words or phrases commonly associated with “office” such as “boss,” “desk,” “chair,” “pencil,” “pen” and “computer.” Then for example, the commonality detector 114 may parse the content 115A-D for the commonality criteria 116 to determine what content is common among or commonly associated with the search results 108.

As referenced above, in addition to rules related to syntactically similar or identical terms, the commonality criteria 116 may more generally include rules or criteria for determining common ideas, themes or other subject matter associated with (e.g., included in) the search results 108. For example, the commonality criteria 116 may include groupings of words or phrases that are associated with one another, e.g., in common usage or as defined by user preference. One example grouping may include “radio,” “cd player,” “speakers,” and “stereo.” Then, for example, if the commonality detector 114 examines the search results 108 and determines that a first search result (e.g., the file 110A) contains “radio” while a second search result (e.g., the file 110B) includes “speakers” and “stereo,” then the commonality detector 114 may determine that all of the terms “radio,” “speakers,” and “stereo” constitute common subject matter within the search results 108, even though the specific terms may be different from one another, as in this example.

Thus, such common subject matter may include words, content, phrases, ideas, themes, terms or other subject matter determined to be common for the purposes of the browsable search system 102. For example, the result selector 112 may provide a subset of the search results 108 to the commonality detector 114, which may then parse the content 115A-D associated with the subset of search results 108 based on the commonality criteria 116. The common subject matter 118A and 118B may be exclusive of the search terms 106. For example, if the search term 106 “house” is used, then the common subject matter 118A and 118B may not contain the term “house,” but may include other terms such as “door,” “window,” “roof,” and “home.”

A commonality evaluator 120 may parse or otherwise determine, as referenced above, the search results 108 based on the commonality criteria 116 to determine the common subject matter 118A and 118B. For example, the commonality evaluator 120 may load the content 115A-115D into a suitable memory (not shown in FIG. 1), such as a clipboard or cache, and may then parse the content 115A-D associated with the files 110A-D, within the memory, to determine the common subject matter 118A and 118B.

An extractor 122 may then extract common subject matter 118A and 118B, for example common terms, from the memory and as determined by the commonality evaluator 114, from the content 115A-D. For example, the commonality evaluator 114 may flag or otherwise indicate portions of the content 115A determined to be included in the common subject matter 118A and 118B. The extractor 122 may then, for example, extract the flagged portions of the content 115A from the file 110A and provide the common subject matter 118A and 118B. In another example embodiment, the extractor 122 may extract portions of the content 115A-D from the plurality of files 110A-D as the common subject matter 118A and 118B. In other example embodiments, the extractor 122 may not extract specific terms or content from the files 110A-D, but rather may identify terms related to extracted or identified terms.

Commonalities 124 may include a portion of the common subject matter 118A and 118B as extracted by the extractor 122. The commonalities 124 may include the common subject matter 118A and 118B ordered or ranked based on relevancy to the search terms 106. For example, the common subject matter 118A may be found in 80% of the search results 108, while the common subject matter 118B may be found in only 60%, thus the common subject matter 118A may be judged to be more relevant to the search terms 106. In another example embodiment, the commonality criteria 116 may include rules for ranking or ordering the common subject matter 118A and 118B. For example, the common subject matter 118A may be found in the content 115B of the file 110B and thus may be given a greater weight, i.e. deemed more relevant, than the common subject matter 118B, which may not appear the file 110B but may appear in the remaining files 110A, 110C and 110D.

In another example embodiment, the commonalities 124 may not include the common subject matter 118A and 118B as determined by the commonality detector 114, rather the commonalities 124 may include only a representation thereof. For example, the commonality detector 114 may determine that the term “office” was found in the search results 108 and that “pencil,” “desk,” “pen,” and “boss” are associated common terms (e.g. part of the common subject matter 118A and 118B). Then for example, the commonalities 124 may provide “office and related terms” as the common subject matter 118A, wherein a user may select the “related terms” to be provided “pencil,” “desk,” “pen,” and “boss” as the common subject matter 118B. In other example embodiments, the commonalities 124 may include other various representations of the common subject matter 118A and 118B as determined by the commonality detector 114.

A view generator 126 may provide the search terms 106, at least a portion of the search results 108, and the commonalities 124 to an interface 128. The view generator 126 may, for example, only provide the selection of the search results 108 as determined by the result selector 112 to be parsed by the commonality detector 114. In another example embodiment, the view generator 126 may provide all the search results 108 even though only a selection was selected by the result selector 112 to be parsed by the commonality detector 114.

The interface 128 may receive and display the search terms 106, the at least a portion of the search results 108, and the commonalities 124 as provided by the view generator 126. For example, the interface 128 may display the search terms 106 in association with the search results 108 and the commonalities 124. The interface 128 may be configured to receive the search terms 106 as entered by a user of the system 100. The interface 128 may be configured to provide the commonalities 124 as being selectable by a user who may select at least a portion of the commonalities 124 for a subsequent search.

A request handler 130 may receive a selection of a portion of the commonalities 124 or the common subject matter 118A and 118B on which a subsequent or second search is to be performed. For example, a user may select via the interface 128, the common subject matter 118A. Then, for example, the request handler 130 may receive or otherwise determine the selected common subject matter 118A and provide the common subject matter 118A to the search engine 104.

The search engine 104 may then perform a subsequent search using the selected common subject matter 118A and/or the search terms 106. The subsequent search may include a plurality of different forms. For example, the subsequent search may include searching the same files 110A-D as were searched for the prior search. In another example embodiment, the subsequent search may be of a subset of the files 110A-D, or may include different files (not shown). In another example embodiment, the search engine 104, during the subsequent search may include a search for the selected common subject matter 118A, 118B and/or at least a subset of the original search terms 106. In another example embodiment, a second or different search engine 104 may (additionally or alternatively) be used to perform the subsequent search.

Upon determining search results 108 associated with the subsequent search, again the commonality detector 114 may determine common subject matter 118A, 118B common to the files of the subsequent search. Then for example, a user may further refine or focus the search via another search by again selecting one or more of the common subject matter 118A, 118B associated with the subsequent search.

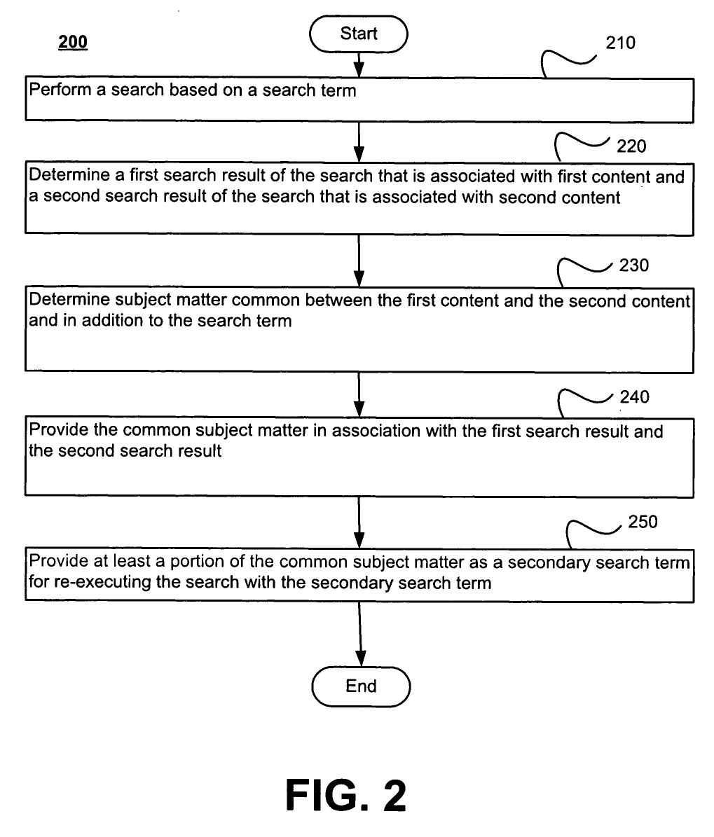

FIG. 2 is a flowchart 200 illustrating example operations of the system of FIG. 1. More specifically, FIG. 2 illustrates an operational flow 200 representing example operations related to a system for browsing search results.

After a start operation, a search may be performed based on a search term (210). For example, as shown in FIG. 1, the search engine 104 may perform a search based on the search terms 106.

A first search result of the search that is associated with first content and a second search result associated with a second content may be determined (220). For example, the search engine 104 may provide the search results 108. The search results 108 may be associated with the files 10A and 10B, including the content 115A and 115B.

Subject matter common between the first content and the second content and in addition to the search term may be determined (230). For example, the commonality detector 114 may determine the common subject matter 118A and 118B from the content 115A and 115B, without including the search terms 106 (which, as pointed out above, are generally contained by definition within the search results 108). In another example embodiment, the common subject matter 118A may be determined by the commonality detector 114, as discussed above, by evaluating at least a portion of the search results 108, including the files 110A-D and the content 115A-D.

Then, the common subject matter may be provided in association with the first search result and the second search result (240). For example, the view generator 126 may provide to the interface 128 the search terms 106 to be displayed in association with the search results 108 and the commonalities 124, including the common subject matter 118A and 118B.

Then, at least a portion of the common subject matter may be provided as a secondary search term for re-executing the search with the secondary search term (250). For example, the request handler 130 may receive one or more of the common subject matter 118A and 118B as selected from the interface 128, and may provide the selected common subject matter 118A and 118B to the search engine 104 to perform a subsequent search.

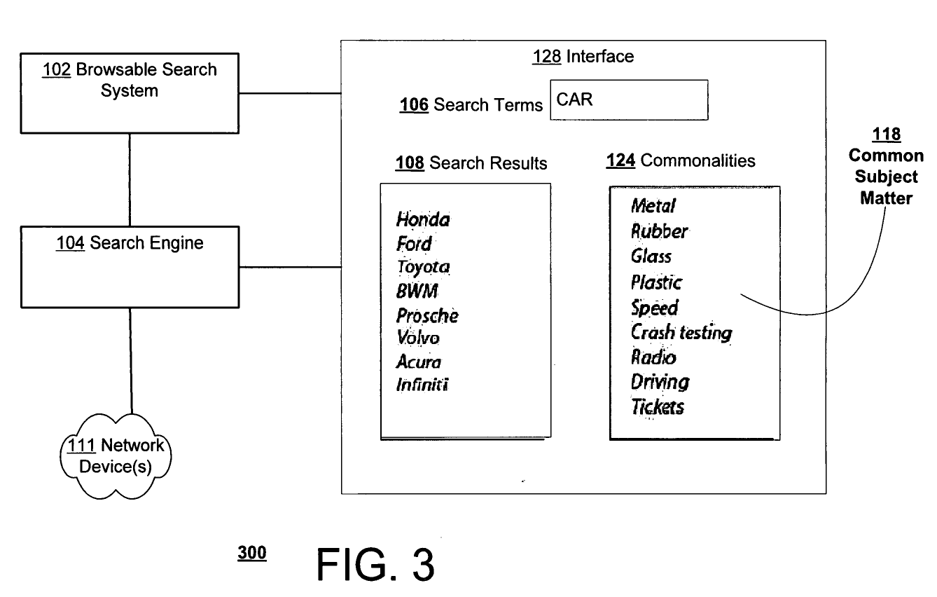

FIG. 3 is a block diagram of an example system 300 for a browsable search system, according to an example embodiment. In the example of FIG. 3, the system 300 may include components that are similar or substantially similar to like numbered components of FIG. 1.

In the system 300, the search engine 104 may receive the search term 106 “CAR” from the interface 128. The search engine 104 may then, for example, search the device 111 (or network of devices, e.g., the Internet), may include a plurality of websites, for “CAR”. The search engine 104 may find 500 results associated with the search term 106 “CAR.” The browsable search system 102 may then select only the top eight search results 108 to parse for common content.

The browsable search system 102 may accordingly parse the search results 108 for content common and return the commonalities 124, including the common subject matter 118. The interface 128 may then display the search terms 106 in association with the search results 108 and the commonalities 124 including the common subject matter 118. In another example embodiment, the common subject matter 118 may only represent a selection of a broader set of common subject matter found among the search results 108.

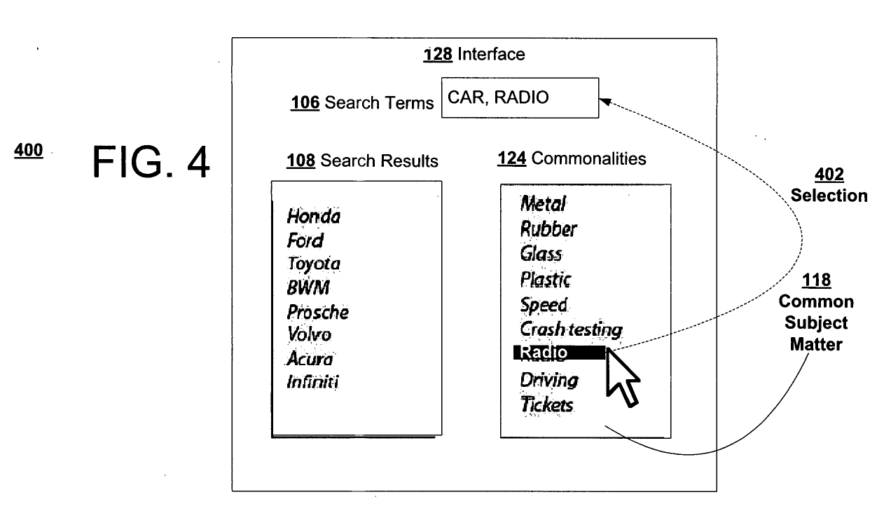

FIG. 4 is a block diagram of an example system 400 for a browsable search system, according to an example embodiment. In the example of FIG. 4, the system 400 may include components that are similar or substantially similar to like numbered components of FIG. 3.

In FIG. 4, the system 400 may be a continuation of the system 300 of FIG. 3, where a user may select one or more of the common subject matter 118 for which to perform a subsequent search. As just discussed, a selection 402 may be made of one or more of the common subject matter 118 to include in a subsequent search. For example, the selection 402 may include a selection of the common subject matter 118 “Radio.” Then for example, the selection 402 may be provided as an additional search term 106 (e.g., by the request handler 130). Then, for example, a subsequent search may include the search terms 106 “CAR” and “RADIO.”

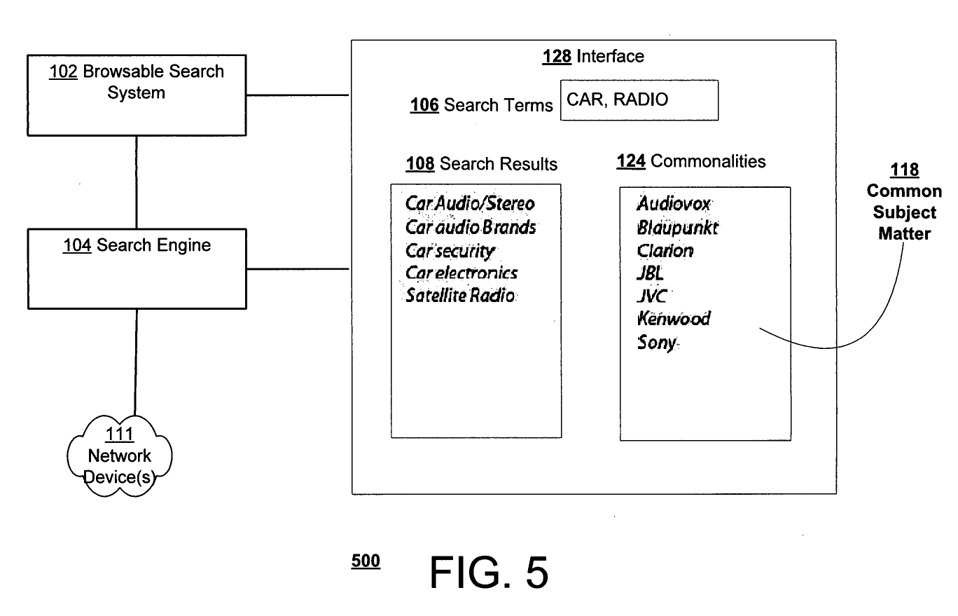

FIG. 5 is a block diagram of an example system 500 for a browsable search system, according to an example embodiment. In the example of FIG. 5, the system 500 may include components that are similar or substantially similar to like numbered components of FIG. 3 and FIG. 4.

In FIG. 5, the system 500 may be a continuation of the systems 300 of FIG. 3 and 400 of FIG. 4, where a user may have selected one or more of the common subject matter 118 for which to perform a subsequent search.

In the system 500, the search engine 104 may have performed the subsequent search on the search terms 106 “CAR” and “RADIO” (in contrast to the search by the system 300 for only “CAR”). According to an example embodiment the search engine 104 (or another search engine) in performing the subsequent search may have searched the network device(s) 111 and/or the prior search results 108 of FIG. 4. Then for example, as discussed above, the interface 128 may display the search terms 106 in association with the subsequent search results 108 and the commonalities 124 including the common subject matter 118 associated with the subsequent search results 108, as provided by the browsable search system 102.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A system comprising:
a commonality detector configured to determine common subject matter associated with search results determined based at least in part on one or more search terms;
a view generator configured to provide the one or more search terms, the search results and the common subject matter; and
a search engine configured to determine secondary search results based at least in part on a selection of the common subject matter.

2. The system of claim 1 comprising:
a result selector configured to select a subset of the search results for determining the common subject matter therefrom by the commonality detector.

3. The system of claim 1 wherein the common subject matter includes common content included in at least a selection of content associated with the search results.

4. The system of claim 1 wherein the common subject matter includes words, themes, ideas and other matter determined to be associated with at least a selection of the search results.

5. The system of claim 1 comprising:
a request handler configured to receive an identification of the selection of the common subject matter, and configured to provide the selection to the search engine for use in executing a subsequent search using at least a portion of the selection as a secondary search term.

6. The system of claim 1 wherein the commonality detector is configured to determine the common subject matter based at least in part on metadata associated with the at least two search results.

7. The system of claim 1 wherein the commonality detector includes commonality criteria comprising rules for determining the common subject matter.

8. The system of claim 7 including a commonality evaluator configured to parse the search results based on the commonality criteria and determine the common subject matter.

9. The system of claim 8 wherein the commonality detector comprises a commonality extractor configured to extract common subject matter based on an output of the commonality evaluator.

10. The system of claim 7 wherein the commonality detector is configured to order the common subject matter based at least in part on the commonality criteria.

11. A method comprising:
determining a plurality of search results of a search based on one or more search terms, the plurality of search results including a first search result associated with first content and a second search result associated with second content;
determining common subject matter associated with the first content and the second content;
providing at least a portion of the common subject matter, other than the one or more search terms, in association with the first search result and the second search result; and
providing at least a selection of the portion of the common subject matter as one or more secondary search terms for re-executing the search.

12. The method of claim 11 wherein determining a plurality of search results comprises:
receiving the plurality of search results from a search engine; and
selecting at least a subset of the search results, including the first search result and the second search result.

13. The method of claim 11 wherein the determining a plurality of search results comprises determining the first search result and the second search result from the plurality of search results based on relevance to the one or more search terms.

14. The method of claim 11 wherein the determining common subject matter comprises:
determining one or more strings included in both the first content and the second content; and
copying the one or more strings from the first content.

15. The method of claim 11 further comprising:
determining a plurality of second search results of a second search based on the selection, the plurality of second search results including a third search result associated with third content and a fourth search result associated with fourth content; and
providing common subject matter between the third content and the fourth content as one or more third search terms for re-executing the search.

16. The method of claim 11 wherein the search is performed on a first plurality of files and the second search is performed on a second plurality of files.

17. A computer program product for searching and browsing files, the computer program product being tangibly embodied on a computer-readable medium and including executable code that, when executed, is configured to cause a data processing apparatus to provide a user interface comprising:
a first field configured to receive one or more first search terms on which to base a first search of a plurality of files;
a second field configured to provide search results associated with the first search; and
a third field configured to provide common subject matter, in addition to the first search terms, associated with the search results, wherein the third field is configured to provide for a selection of at least a portion of the common subject matter as a second search term for a second search.

18. The computer program product of claim 17 wherein the first field is further configured to receive the second search term, as selected, on which to base, at least in part, a second search of at least a subset of the plurality of files.

19. The computer program product of claim 17 wherein the second search is based on one or more of the first search terms and the second search term.

20. The computer program product of claim 17 wherein the third field is configured to provide the selection of the common subject matter based on relevancy to one or more of the first search terms and/or the second search term.
